(19) United States
(12) Patent Application Publication
(10) Pub. No.: US 2025/0023297 A1
(43) Pub. Date: Jan. 16, 2025

(54) METHOD FOR PRE-DETERMINING LOCK JAMMING OF ELECTRONIC LOCK OF SOCKET-TYPE CHARGING PILE, CHARGING PILE AND CHARGING APPARATUS

(71) Applicant: Autel Digital Power Co., Ltd., Shenzhen (CN)

(72) Inventor: Yunfeng XU, Shenzhen (CN)

(73) Assignee: Autel Digital Power Co., Ltd., Shenzhen (CN)

(21) Appl. No.: 18/900,630

(22) Filed: Sep. 27, 2024

Related U.S. Application Data
(63) Continuation of application No. PCT/CN2023/077379, filed on Feb. 21, 2023.

(30) Foreign Application Priority Data
Apr. 1, 2022 (CN) 202210339516.3

(51) Int. Cl. H01R 13/639; B60L 53/16; B60L 53/60

(52) U.S. Cl. CPC H01R 13/639; B60L 53/16; B60L 53/60

(57) ABSTRACT

Provided are a method for pre-determining lock jamming of an electronic lock of a charging pile, a charging pile and a charging apparatus. The charging pile is provided with a socket, an electronic lock is installed on the socket for performing switching operation on a charging gun which is inserted into the socket. The method includes acquiring time distribution data including one or more switching time during which the electronic lock performs the switching operation on the one or more charging guns, generating one or more lock jamming features corresponding to the one or more switching time according to the time distribution data, and pre-determining whether the electronic lock is in a lock jamming critical state according to the one or more lock jamming features.

### CROSS-REFERENCE TO RELATED APPLICATIONS

This application is a continuation application of International Application No. PCT/CN2023/077379, filed on Feb. 21, 2023, which claims priority to Chinese Patent Application No. 202210339516.3, filed on Apr. 1, 2022, all of which are incorporate herein by reference in their entireties for all purposes.

### TECHNICAL FIELD

The present disclosure relates to the technical field of new energy sources, and in particular to a method for pre-determining lock jamming of an electronic lock of a socket-type charging pile, a charging pile and a charging apparatus.

### BACKGROUND

With the advent of the new energy revolution, more and more electric vehicles appear in the market. In order to meet the charging needs of electric vehicle, electric vehicle manufacturers widely distribute charging piles. A vehicle owner can use the charging gun of a charging pile to insert a charging socket of the charging gun into a charging port of an electric vehicle for charging. However, since the existing charging pile cannot pre-determine the lock jamming critical state of a charging pile, lock jamming easily occurs during the process that the vehicle owner uses the charging gun to charge the electric vehicle, or when the vehicle owner drives the electric vehicle to the charging pile, he may find that the charging gun cannot effectively form a tight locking state with the electric vehicle, resulting in that the charging pile cannot provide the charging service.

### SUMMARY

The present disclosure provides a method for pre-determining lock jamming of an electronic lock of a socket-type charging pile, a charging pile and a charging apparatus.

The first aspect of the present disclosure provides a method for pre-determining lock jamming of an electronic lock of a charging pile, the method including: acquiring time distribution data, wherein the charging pile is provided with a socket, the electronic lock is installed on the socket for performing a switching operation on one or more charging guns which are inserted into the socket, and the time distribution data comprises one or more switching time during which the electronic lock performs the switching operation on the one or more charging guns; generating one or more lock jamming features corresponding to the one or more switching time according to the time distribution data; and pre-determining whether the electronic lock is in a lock jamming critical state according to the one or more lock jamming features.

The second aspect of the present disclosure provide a socket-type charging pile including: a pile body; a socket installed on the pile body for inserting in a charging gun; an electronic lock installed on the socket; and a controller electrically connected to the electronic lock for performing the above-mentioned method for pre-determining lock jamming of an electronic lock of a charging pile.

The third aspect of the present disclosure provides a charging apparatus including: the above-mentioned socket-type charging pile; a charging gun including a gun body, a pile body plug and a vehicle plug, wherein the pile body plug and the vehicle plug are respectively installed on two ends of the gun body, and the electronic lock is used for performing a switching operation on the pile body plug.

The fourth aspect of the present disclosure provides a non-transitory computer-readable storage medium storing computer-executable instructions for causing an electronic device to perform the method for pre-determining lock jamming of an electronic lock of a socket-type charging piles as described above.

The fifth aspect of the present disclosure provides a computer program product including a computer program stored on a non-transitory computer readable storage medium, the computer program including program instructions which, when executed by an electronic device, cause the electronic device to perform the method for pre-determining lock jamming of an electronic lock of a socket-type charging pile as described above.

The sixth aspect of the present disclosure provides an electronic device including: at least one processor; and a memory communicatively connected to the at least one processor. The memory stores an instruction executable by the at least one processor, and the instruction is executed by the at least one processor to enable the at least one processor to perform the method for pre-determining lock jamming of an electronic lock of a socket-type charging pile as described above.

In the method for pre-determining lock jamming of an electronic lock of a socket-type charging pile provided in the present disclosure, on the one hand, the charging pile is provided with a socket, an electronic lock is installed on the socket for locking or unlocking a charging gun which is inserted into the socket, and the charging gun and the charging pile provided by the present embodiment are separate, such that a user inserts the charging gun into the charging pile when charging is required, thereby facilitating better maintenance of the charging gun. On the other hand, according to the present embodiment, time distribution data can be acquired, where the time distribution data includes one or more switching time duration during which the electronic lock performs a switching operation on one or more charging guns; one or more lock jamming features corresponding to the switching time are generated according to the time distribution data; and whether the electronic lock is in a lock jamming critical state is pre-determined according to the one or more lock jamming features. Therefore, according to the present disclosure, whether the electronic lock is in the lock jamming critical state can be automatically pre-determined, so that a manager of the charging pile takes corresponding maintenance work, which is beneficial to improving user experience.

### BRIEF DESCRIPTION OF DRAWINGS

One or more embodiments are illustrated by way of example and not by way of limitation in the figures of the accompanying drawings, in which elements having the same reference numeral designations represent similar elements, and in which the figures are not to scale unless otherwise specified.

FIG. 1 is a schematic structural diagram showing a charging apparatus according to some embodiments of the present disclosure;

FIG. 2 is a schematic structural diagram showing a charging pile as shown in FIG. 1;

FIG. 3 is a front view of a socket as shown in FIG. 2;

FIG. 4 is a schematic structural diagram showing a first circuit of an electronic lock as shown in FIG. 2;

FIG. 5 is a schematic structural diagram showing a second circuit of an electronic lock as shown in FIG. 2;

FIG. 6 is a schematic diagram showing a charging scene according to some embodiments of the present disclosure;

FIG. 7 is a schematic flow chart of a method for pre-determining lock jamming of an electronic lock of a charging pile according to some embodiments of the present disclosure;

FIG. 8 is a flow chart of S72 as shown in FIG. 7;

FIG. 9 is a flow chart of S721 as shown in FIG. 8;

FIG. 10 is a flow chart of S7211 as shown in FIG. 9;

FIG. 11 is a flow chart of S75 as shown in FIG. 10;

FIG. 12 is a first flow chart of S723 as shown in FIG. 8;

FIG. 13 is a first flow chart of S73 as shown in FIG. 7;

FIG. 14 is a second flow chart of S723 as shown in FIG. 8;

FIG. 15 is a second flow chart of S73 as shown in FIG. 7; and

FIG. 16 is a schematic structural diagram showing a circuit of an electronic device according to some embodiments of the present disclosure.

### DETAILED DESCRIPTION

So that the objects, aspects and advantages of the present disclosure may be more clearly understood, a more particular description of the invention, briefly summarized below, is provided by reference to the appended drawings and examples. It should be understood that the particular embodiments described herein are illustrative only and are not restrictive. Based on the embodiments in the present disclosure, all other embodiments obtained by a person skilled in the art without involving any inventive effort are within the scope of protection of the present disclosure.

It should be noted that, if not in conflict, the various features of the embodiments of the present disclosure may be combined with of the present disclosure. In addition, although the division of functional modules is illustrated in a schematic diagram showing an apparatus and a logical order is illustrated in a flowchart, in some cases, the steps illustrated or described may be performed in an order other than the division of the modules the apparatus or in the flowchart. Furthermore, the words “first”, “second”, “third”, and the like, as used herein do not limit the data and order of execution, but merely distinguish the same item or similar item having substantially the same function or action.

Embodiments of the present disclosure provide a charging apparatus, where the charging apparatus is adaptable to any type of electric vehicle, the electric vehicle includes a pure electric vehicle, a hybrid electric vehicle, or an electric automobile, etc.

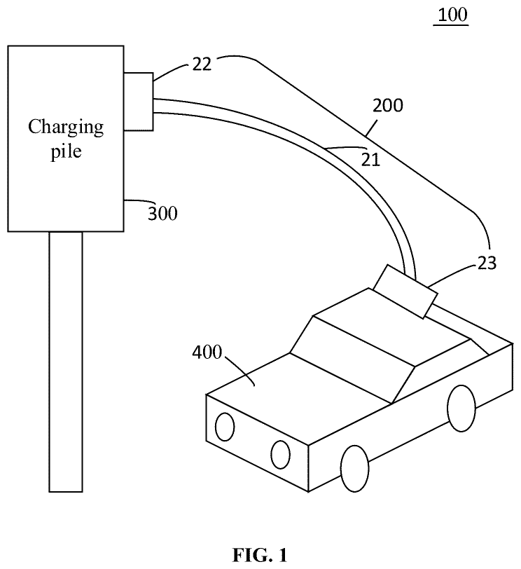

Referring to FIG. 1, the charging apparatus 100 includes a charging gun 200 and a charging pile 300, where the charging pile 300 is a socket-type charging pile, and the charging pile 300 is separated from the charging gun 200.

The charging gun 200 is used for transmitting electric energy provided by the charging pile 300 to the electric vehicle 400, where the charging gun 200 includes a gun body 21, a pile body plug 22 and a vehicle plug 23, where the pile body plug 22 and the vehicle plug 23 are respectively installed at two ends of the gun body 21.

The gun body 21 has a strip shape, and is provided with an accommodating cavity therein for accommodating each power cable.

The pile body plug 22 is provided with an insertion hole on an outer surface thereof, and when it is necessary to fix the charging gun 200 to the charging pile 300, an electronic lock of the charging pile 300 is inserted into the insertion hole, so that the charging gun 200 can be locked. When it is desired to remove the charging gun 200 from an interior of the charging pile 300, the electronic lock of the charging pile 300 is removed from the insertion hole so that the charging gun 200 can be released.

The vehicle plug 23 is used to be inserted into the vehicle charging plug of the electric vehicle 400, and the electric energy of the charging pile 300 is applied to the vehicle charging plug through the pile body plug 22 of the charging gun 200, the power cable of the gun body 21 and the vehicle plug 223 to supply the electric vehicle 400 with electric energy.

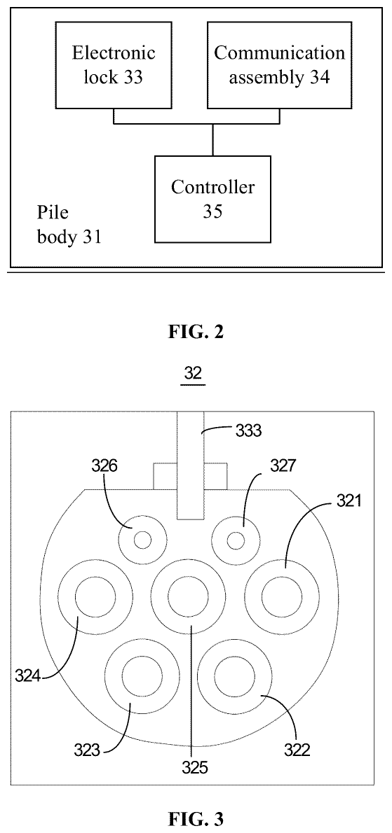

The charging pile 300 is used for supplying power to the electric vehicle 400 through the charging gun 200, wherein referring to FIGS. 2 and 3, the charging pile 300 includes a pile body 31, a socket 32, an electronic lock 33, a communication assembly 34 and a controller 35.

The pile body 31 is installed on the ground for carrying various components. The pile body 31 may be constructed of any suitable material.

The socket 32 is installed on the pile body 31 for inserting the charging gun 200. The socket 32 includes a first phase power terminal 321, a second phase power terminal 322, a third phase power terminal 323, a neutral terminal 324, a ground terminal 325, a handshake terminal 326, and a control terminal 327.

The first phase power terminal 321, the second phase power terminal 322, the third phase power terminal 323, and the neutral terminal 324 are used to collectively boost a three-phase power. The ground terminal 324 is used for grounding.

The handshake terminal 326 is used for transmitting a handshake signal for confirming whether the handshake between the charging pile 300 and the charging gun 200 is successful, and when the handshake signal is a first-type handshake signal, the charging pile 300 confirms that the handshake between the charging gun 200 is successful, i.e., when the charging gun 200 is correctly inserted in the socket 32, the charging gun 200 sends the first-type handshake signal to the charging pile 300, or the charging pile 300 can generate the first-type handshake signal. When the handshake signal is a second type handshake signal, the charging pile 300 confirms that it has not had a handshake with the charging gun 200, i.e., that the charging gun 200 has not been correctly inserted into the socket 32, the charging pile 300 is able to generate the second type handshake signal.

In some embodiments, the first type handshake signal is high level and the second type handshake signal is low level, or the first type handshake signal is low level and the second type handshake signal is high level.

It will be appreciated that the number of contacts and placement of the sockets 32 are adapted to the pile body plug 22 and the vehicle plug 23, respectively.

The control terminal 327 is used to transmit a control signal, where the control signal is a signal satisfying a charging pile protocol, and the charging pile 300 is in interactive communication with the charging gun 200 based on the control signal transmitted by the control terminal 327.

The electronic lock 33 is installed on the socket 32 and is electrically connected to the controller 35 for locking or unlocking the pile body plug. For example, the electronic lock 33 is controlled by the controller 35 to lock or unlock the charging gun 200 inserted into the socket 32. When it is required to fix the charging gun 200 to the charging pile 300, the electronic lock 33 performs a locking operation, i.e., the electronic lock 33 is inserted into the insertion hole of the pile body plug 22. When it is desired to remove the charging gun 200 from the charging pile 300, the electronic lock 33 performs an unlocking operation, i.e., the electronic lock 33 is removed from the insertion hole of the pile body plug 22.

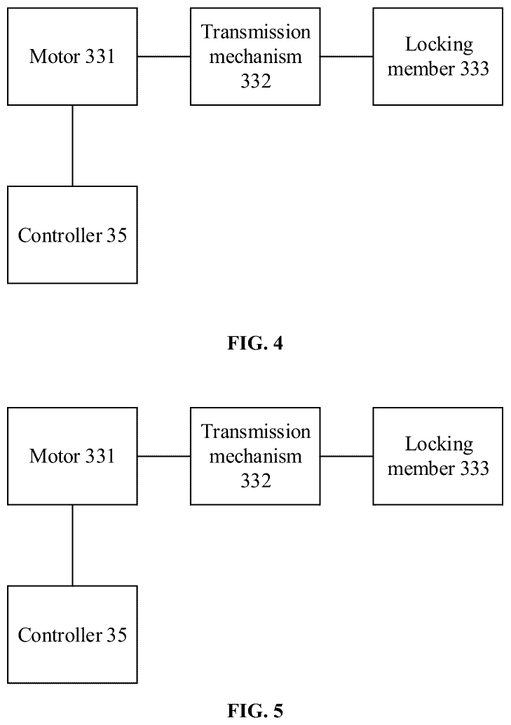

Referring to FIG. 4, the electronic lock 33 includes a motor 331, a transmission mechanism 332, and a locking member 333.

The motor 331 is electrically connected to the controller 35 for entering a corresponding operation state in response to a control command sent by the controller 35, where the operation state includes an unlocking operation state, a locking operation state and a lock jamming release operation state, and when the control command is an unlock command, the controller 35 can control the motor 331 to enter the unlocking operation state. When the control command is a lock command, the controller 35 can control the motor 331 to enter a locking operation state. When the control command is a lock jammed command, the controller 35 can control the motor 331 to enter a lock jamming release operation state.

In some embodiments, the motor 331 may be a stepper motor or a servo motor or the like.

The transmission mechanism 332 is connected to the motor 331 for being driven by the motor 331 to perform transmission work, where the transmission mechanism 332 includes a screw rod and a screw sleeve, the screw rod is connected to an output shaft of the motor 331, the screw sleeve is sleeved on the screw rod, the motor 331 is controlled by the controller 35 to drive the screw rod to rotate, and the screw rod drives the screw sleeve to be movable on the screw rod.

It is to be understood that the transmission mechanism 332 may include other suitable components in addition to the above-mentioned components, for example, the transmission mechanism 332 includes a gear transmission mechanism and a connecting rod transmission mechanism, the motor 331 is connected to the gear transmission mechanism, the gear transmission mechanism is connected to the connecting rod transmission mechanism, and the motor 331 is controlled by the controller 35 and drives the gear transmission mechanism to drive the connecting rod transmission mechanism to move.

The locking member 333 is connected to the transmission mechanism 332, and the transmission mechanism 332 can drive the locking member 333 to lock or unlock the charging gun 200, for example, when the locking operation is performed, the transmission mechanism 332 drives the locking member 333 to be inserted into the insertion hole of the pile body plug 22 to unlock the charging gun 200. When the unlocking operation is performed, the transmission mechanism 332 drives the locking member 333 to move out of the insertion hole of the pile body plug 22 to unlock the charging gun 200.

The working principle of the electronic lock 33 performing the unlocking operation and the locking operation is described below, and the details are as follows:

the controller 35 controls the motor 331 to enter the locking operation state according to the lock command, and the motor 331 drives the transmission mechanism 332 to move the locking member 333 toward the insertion hole of the charging gun 200 until the locking member 333 is inserted into the insertion hole, thereby completing the locking operation.

The controller 35 controls the motor 331 to enter the unlocking operation state according to the unlock command, and the motor 331 drives the transmission mechanism 332 to move the locking member 333 in a direction away from the insertion hole of the charging gun 200 until the locking member 333 moves out of the insertion hole, thereby completing the unlocking operation.

In some embodiments, referring to FIG. 5, the electronic lock 33 further includes a travel switch 334 provided within the electronic lock 33 and electrically connected to the controller 35 for generating a position signal to detect the position of the locking member 333.

In some embodiments, the number of travel switches 334 is at least two, with a first travel switch provided at a tongue start position of the electronic lock and a second travel switch provided at a tongue end position of the electronic lock, where the tongue start position is defined as a start point at which the locking member 333 begins to perform a locking operation and the tongue end position is defined as a start point at which the locking member 333 begins to perform an unlocking operation.

When the motor 331 enters the locking operation state, the transmission mechanism can be driven to drive the locking member 333 to move from the tongue start position, and when the position of the locking member 333 reaches the tongue end position, the second travel switch generates a high-level position signal, where the high-level position signal is used for indicating that the locking member 333 has moved into the insertion hole of the charging gun 200, i.e., the locking operation is completed.

When the motor 331 enters the locking operation state, if the controller 35 does not detect the high level of the second travel switch, the controller 35 determines that the locking operation has not been completed.

When the motor 331 enters the unlocking operation state, the transmission mechanism can be driven to drive the locking member 333 to move from the tongue end position, and when the position of the locking member 333 reaches the tongue start position, the first travel switch generates a high-level position signal, wherein the high-level position signal is used for indicating that the locking member 333 has moved into the insertion hole of the charging gun 200, i.e., the locking operation is completed.

When the motor 331 enters the unlocking operation state, if the controller 35 does not detect the high level of the first travel switch, the controller 35 determines that the unlocking operation has not been completed.

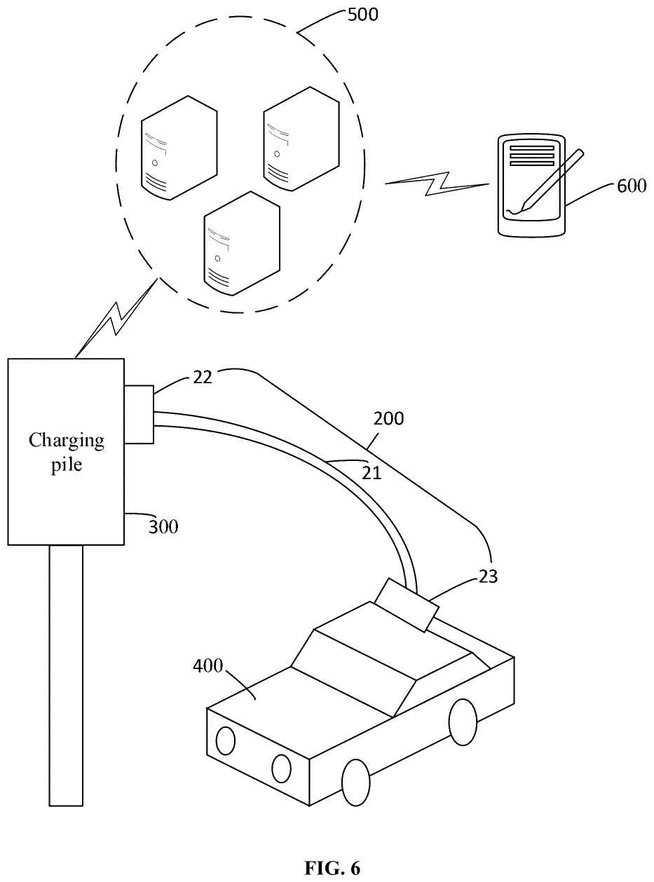

The communication assembly 34 is connected to the controller 35 for communicating with an external device, where the external device may be a server and/or a mobile terminal. Referring to FIG. 6, the external devices are a server 500 and a mobile terminal 600, respectively.

The server 500 communicates with the charging pile 300 via the communication assembly 34, for example, the server 500 can send charging end configuration information to the charging pile 300, and the charging configuration information is used for configuring corresponding working parameters of the charging pile 300, for example, the charging pile 300 updates a power monitoring threshold according to the charging configuration information, and the power monitoring threshold is used for the charging pile 300 to monitor whether the output power is excessive to ensure the security of the charging pile 300 when charging. For another example, the charging pile 300 can send working parameter information to the server 500, and the server 500 parses the working parameter information and judges the operation condition of the charging pile 300 according to the parsing result to effectively maintain the charging pile 300.

In some embodiments, the server 500 may be a physical server or a logical server formed by virtualizing multiple physical servers. The server 500 may also be a server group formed by a plurality of servers capable of communicatively connected with each other, and each functional module may be distributed on each server in the server group.

The mobile terminal 600 can communicate with the server 500 and issue control commands to the charging pile 300 through the server 500.

In some embodiments, the mobile terminal 600 supports the installation of various desktop applications, such as: charging service application, photo application or video application, etc.

A user can install a charging service application in the mobile terminal 600, and send registration information to the server 500 via the charging service application, where the registration information includes user information needing to be registered and a password, and the server 500 allocates an account number which is authorized and authenticated for the user according to the registration information.

When the user completes the registration, the user can operate the mobile terminal 600 to start a charging service application, and a login interface of the charging service application includes an account number input area, a password input area and a login key, where the account number input area is used for inputting a legally authenticated account number, the password input area is used for inputting a password corresponding to the account number, and the login key is used for responding to the login key operation of the user and sending a login request to the server 500, and the login request carries the account number and the password. The server 500 authenticates whether the account and password are legal according to the login request, and if so, controls the mobile terminal 600 to log into the charging service application, and if not, refuses the mobile terminal 600 to log into the charging service application.

When the mobile terminal 600 logs in the charging service application, a user can establish a charging gun archive in the charging service application, where the charging gun archive includes device information about the charging gun and charging information under the device information, and the device information about the charging gun is a device serial number of the charging gun.

The charging information includes a charging position, a charging pile identifier, a charging time, a charging duration and a switching time when the charging gun performs charging on the charging pile, where the charging position is a geographical position of the charging pile, the charging pile identifier is an identifier for marking the charging pile, and the charging time includes a charging start time and a charging end time; where the charging start time is a time when the electric vehicle of the user starts to be charged on the charging pile, the charging end time is a time when the electric vehicle of the user finishes charging on the charging pile, and the charging duration is a time span during which the electric vehicle of the user is being charged on the charging pile; the switching time is a time span during which the charging pile unlocks or locks the charging gun, that is, the switching time can be either the unlocking time or the locking time, or the sum of the unlocking time and the locking time of the same charging process.

Table 1 is provided to illustrate a charging gun archive as follows:

TABLE 1
Charging gun Q1 (SNQ10012)-Archive

| | Device | | | | |
|---|---|---|---|---|---|
| | information | | | | |
| | of the | | | | |
| Charging | charging | Charging start | Charging end | Charging | |
| position | pile | time | time | duration | Switching time |
| Luohu A | SNZ10000 | 12:00, | 12:30, | 30 minutes | Locking time: 1.0 |
| Building | | Feb. 9, 2022 | Feb. 9, 2022 | | seconds |
| | | | | | Unlocking time: 0.9 |
| | | | | | seconds |
| Futian B | SNZ20022 | 11:00, | 11:45, | 45 minutes | Locking time: 1.0 |
| Building | | Feb. 10, 2022 | Feb. 10, 2022 | | seconds |
| | | | | | Unlocking time: 1.0 |
| | | | | | seconds |
| Luohu A | SNZ10001 | 10:00, | 11:00, | 60 minutes | Locking time: 0.9 |
| Building | | Feb. 12, 2022 | Feb. 12, 2022 | | seconds |
| | | | | | Unlocking time: 0.9 |
| | | | | | seconds |
| Nanshan | SNZ30045 | 12:00, | 12:50, | 50 minutes | Locking time: 0.9 |
| C | | Feb. 14, 2022 | Feb. 14, 2022 | | seconds |
| Building | | | | | Unlocking time: 1.0 |
| | | | | | seconds |

It can be seen from Table 1 that the charging gun Q1 can be inserted into different charging piles for charging, and the server 500 and the mobile terminal 600 can record the switching time of the charging gun Q1, for example, the switching time set of the charging gun is {(1.0, 0.9), (1.0, 1.0), (0.9, 0.9), (0.9, 1.0)}.

It will be appreciated that since the charging pile and the charging gun are separate, as shown in Table 1, the same charging gun can be inserted into different charging piles for charging. Similarly, the same charging pile provides power to different charging guns, see Table 2:

TABLE 2
Charging pile Z1 (SNZ10000)-Archive

| | Device | | | | |
|---|---|---|---|---|---|
| | information of | | | | |
| | the charging | Charging start | Charging end | Charging | |
| User account | gun | time | time | duration | Switching time |
| 15011112222 | SNQ10012 | 12:00, | 12:30, | 30 minutes | Locking time: |
| | | Feb. 9, 2022 | Feb. 9, 2022 | | 1.0 seconds |
| | | | | | Unlocking time: |
| | | | | | 0.9 seconds |
| 13633334444 | SNQ20034 | 13:00, | 13:40, | 40 minutes | Locking time: |
| | | Feb. 9, 2022 | Feb. 9, 2022 | | 0.8 seconds |
| | | | | | Unlocking time: |
| | | | | | 1.0 seconds |
| 18955556666 | SNQ10056 | 14:00, | 15:30, | 90 minutes | Locking time: |
| | | Feb. 9, 2022 | Feb. 9, 2022 | | 1.0 seconds |
| | | | | | Unlocking time: |
| | | | | | 0.9 seconds |
| 13277778888 | SNQ30078 | 16:00, | 16:35, | 35 minutes | Locking time: |
| | | Feb. 14, 2022 | Feb. 14, 2022 | | 1.0 seconds |
| | | | | | Unlocking time: |
| | | | | | 0.9 seconds |

As shown in Table 2, the charging pile Z1 can supply power to charging guns of different users, and the server 500 and the charging pile Z1 can record the switching time of the charging pile Z1, for example, the switching time set of the charging pile is {(1.0, 0.9), (0.8, 1.0), (1.0, 0.9), (1.0, 0.9)}.

An embodiment provides a charging application scene to elaborate the charging process of the charging pile Z1, the charging gun Q1, the server 500 and the mobile terminal 600, and the details are as follows:

The user drives the electric vehicle 400 to the vicinity of the charging pile Z1, takes out the charging gun Q1 from the electric vehicle 400, snaps the pile body plug of the charging gun Q1 onto the socket of the charging pile Z1 via a mechanical locking head, and inserts the vehicle plug of the charging gun Q1 on the vehicle charging socket of the electric vehicle 400.

The display screen of the charging pile Z1 presents a two-dimensional code. A user operates the mobile terminal 600 to log in a charging service application, and clicks a scanning key of the charging service application to scan a two-dimensional code then the mobile terminal 600 sends a charging preparation request to the server 500 according to the content of the two-dimensional code, where the charging preparation request carries device information about the charging pile Z1 and device information about the charging gun Q1.

The server 500 determines whether the charging pile Z1 can provide electric energy according to the charging preparation request, and if the charging pile Z1 can provide electric energy, a lock command is sent to the charging pile Z1, and according to the lock command, the charging pile Z1 controls the electronic lock to perform a locking operation and records a locking time, i.e., the motor is controlled to drive the locking member to move in a direction close to the insertion hole of the charging gun Q1 to insert the locking member into the insertion hole, thereby fixing the charging gun Q1.

If the charging pile Z1 cannot provide electric energy, non-charging information is sent to the charging pile Z1, and the charging pile Z1 presenting the non-charging information on the display screen so that the user replaces the charging pile for charging.

When the charging pile Z1 fixes the charging gun Q1, the user clicks a charging start key of a charging UI interface of a charging service application, and the charging start key is used for responding to a charging start operation of the user to prompt the mobile terminal 600 to send a charging start request to the server 500. The server 500 controls the charging pile Z1 to supply power to the charging gun Q1 according to the charging start request, and starts timing.

After the charging is finished, the user clicks a charging end key of a charging UI interface of the charging service application, and the charging end key is used for prompting the mobile terminal 600 to send a charging end request to the server 500 in response to the user's charging end operation. The server 500 controls the charging pile Z1 to stop supplying electric power to the charging gun Q1 according to the charging end request, ends timing, and transmits an unlock command to the charging pile Z1. According to the unlock command, the charging pile Z1 controls the electronic lock to perform an unlocking operation and records the unlocking time, i.e., controls the motor to move the locking member in a direction away from the insertion hole of the charging gun Q1 to move the locking member out of the insertion hole, thereby releasing the charging gun Q1 from the charging pile Z1.

The controller 35 acts as a control core for the charging pile 300, wherein the controller 35 may be a general-purpose processor, a digital signal processor, an application specific integrated circuit, a field programmable gate array, a single chip microcomputer, a ARM or other programmable logic device, discrete gate or transistor logic, discrete hardware components, or any combination of these components. Also, the controller 35 may be any conventional processor, controller, microcontroller, or state machine. The controller 35 may also be implemented as a combination of computing devices, e.g., a combination of a DSP and a microprocessor, a plurality of microprocessors, one or more microprocessors in conjunction with a DSP core, or any other such configuration.

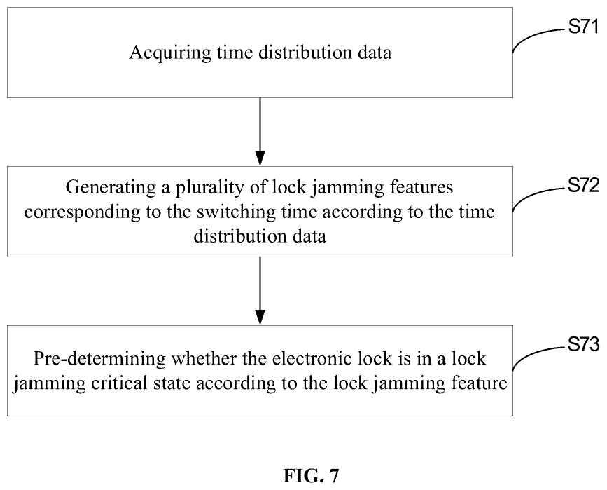

As another aspect of the embodiments of the present disclosure, the embodiments of the present disclosure provide a method for pre-determining lock jamming of an electronic lock of a socket-type charging pile, and it can be understood that the executive body of the method for pre-determining lock jamming of an electronic lock of a socket-type charging pile can be a charging pile, and can also be other devices having a logical operation function and an analysis function, for example, the devices are servers, etc. Referring to FIG. 7, the method for pre-determining lock jamming of an electronic lock of a socket-type charging pile includes:

S71: acquiring time distribution data.

In this step, the time distribution data includes a plurality of switching time for the electronic lock to perform a switching operation on each charging gun, and as previously stated, the switching time is the time span for the charging pile to unlock or lock the charging gun, that is, the switching time can be either the locking time or the unlocking time, or the sum of the unlocking time and the locking time of the same charging process. For example, referring to Table 2, when the switching time is the locking time, the time distribution data T={1.0, 0.8, 1.0, 1.0}. When the switching time is the unlocking time, the time distribution data T={0.9, 1.0, 0.9, 0.9}. The time distribution data T={1.9, 1.8, 1.9, 1.9} when the switching time is the sum of the unlocking time and the locking time of the same charging process.

In some embodiments, the charging pile sends a time acquisition request to the server, wherein the time acquisition request carries device information of the charging pile. The server searches for a charging pile corresponding to the device information according to the time acquisition request, and sends the time distribution data to the charging pile, and the charging pile receives the time distribution data.

S72: generating a plurality of lock jamming features corresponding to the switching time according to the time distribution data.

In this step, the lock jamming feature is a feature for indicating whether the electronic lock is in a lock jamming critical state. The present embodiment generates a lock jamming feature according to a plurality of switching time of the time distribution data in combination with a lock jamming feature extraction rule, where the lock jamming feature extraction rule may be a similarity algorithm or a statistical data processing algorithm, etc.

In some embodiments, a first time mean value is calculated according to a plurality of switching time of the time distribution data, and the first time mean value is used as a lock jamming feature, for example, referring to Table 2, when the switching time is the locking time, the time distribution data T={1.0, 0.8, 1.0, 1.0}, the first time mean value is 0.95 seconds, and the lock jamming feature is 0.95 seconds.

In some embodiments, according to a plurality of switching time of the time distribution data, the present embodiment screens out the number of switching time which are continuous in time and are longer than or equal to a specified threshold, and uses the number as the lock jamming feature of the switch, for example, referring to Table 2, when the switching time is the locking time, the time distribution data T={1.0, 0.8, 1.0, 1.0}, and the specified threshold is 0.9; since two 1.0 seconds following 0.8 seconds are continuous and are both greater than 0.9, the number is 2, and the lock jamming feature is 2.

It can be understood that the type of the extracted lock jamming feature may be different due to different lock jamming feature extraction rules, for example, the lock jamming feature may be a time mean value of the time distribution data, or the number of switching time exceeding a corresponding pre-set threshold in the time distribution data, or the fluctuation rate of the time distribution data.

S73: pre-determining whether the electronic lock is in a lock jamming critical state according to the lock jamming feature.

In this step, the lock jamming critical state is a critical state before the electronic lock enters the lock jamming state, and the locking state is a state where the locking member of the electronic lock is jammed.

In some embodiments, the present embodiment determines whether the lock jamming feature is greater than or equal to a pre-set feature; if the lock jamming feature is greater than or equal to the pre-set feature, the pre-determined electronic lock is in a lock jamming critical state; and if the lock jamming feature is less than the pre-set feature, the pre-determined electronic lock is in a normal state.

In some embodiments, when the first time mean value is a lock jamming feature, the present embodiment determines whether the first time mean value is greater than or equal to a specified time threshold; if the first time mean value is greater than or equal to the specified time threshold, the electronic lock is pre-determined to be in a lock jamming critical state; and if the first time mean value is less than the specified time threshold, the electronic lock is pre-determined to be in a normal state.

In some embodiments, when the number is a lock jamming feature, the present embodiment determines whether the number is greater than or equal to a specified number threshold, if the number is greater than or equal to the specified number threshold, the pre-determined electronic lock is in a lock jamming critical state, and if the number is less than the specified number threshold, the pre-determined electronic lock is in a normal state.

As described above, since the charging pile provided by the present embodiment is provided with a socket, an electronic lock is installed on the socket for locking or unlocking a charging gun which is inserted into the socket, and the charging gun and the charging pile provided by the present embodiment are separate, such that a user inserts the charging gun into the charging pile when charging is required, thereby facilitating better maintenance of the charging gun. In addition, the present embodiment can automatically pre-determine whether the electronic lock is in a lock jamming critical state, so that the manager of the charging pile takes corresponding maintenance work, which is beneficial to improve the user experience.

For the user, the charging pile is separated from the charging gun, and when the user needs to charge the electric vehicle, the pile body plug of the charging gun is inserted into the socket of the charging pile, and the vehicle plug is inserted into the vehicle charging socket of the electric vehicle.

For the same charging pile, different charging guns can be inserted in the same charging pile at different time for charging. Some users have better maintenance of the charging gun when the lock jamming phenomenon occurs, and the lock jamming phenomenon may be caused by the charging pile. Some users have poor maintenance of the charging gun, or the charging gun has a relatively long service life, or is corroded and rusted, or has a relatively large frictional force due to material deformation, and the lock jamming phenomenon at this time may be caused by the charging gun. The switching time of such a charging gun is usually relatively large, and sometimes it is more than the normal switching time once. Thus, the switching time of such a charging gun will raise the overall level of time distribution data, which will cause a misjudgment that the electronic lock of the charging pile is about to enter the lock jamming critical state, and in fact the electronic lock of the charging pile is normal.

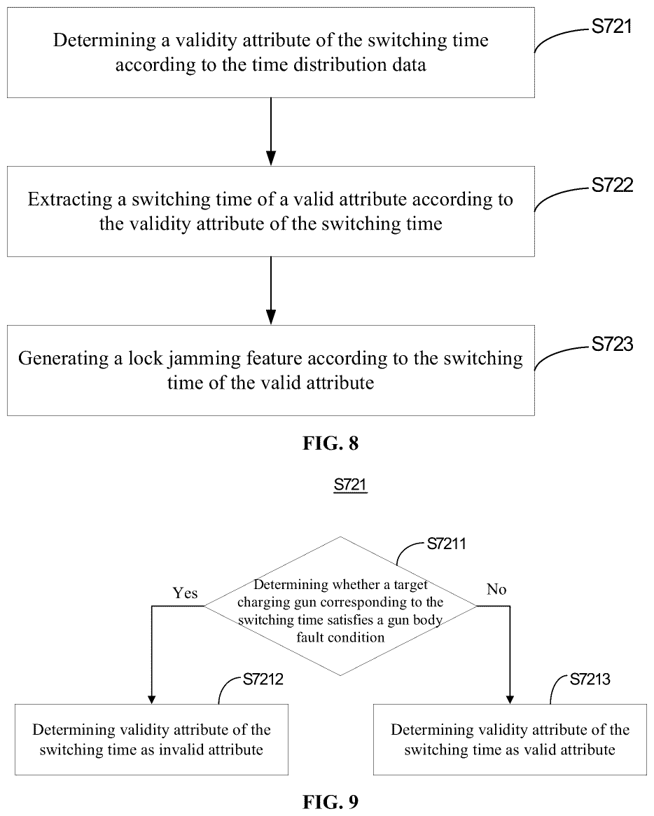

Based on this, in some embodiments, a plurality of switching time is generated corresponding lock jamming features according to the time distribution data, and referring to FIG. 8, S72 includes:

S721: determining a validity attribute of the switching time according to the time distribution data.

S722: extracting a switching time of a valid attribute according to the validity attribute of the switching time.

S723: generating a lock jamming feature according to the switching time of the valid attribute.

In S721, the validity attribute is an attribute of whether the switching time is valid, wherein the validity attribute includes a valid attribute and an invalid attribute, the valid attribute refers to the attribute that the switching time is valid, and the invalid attribute refers to the attribute that the switching time is invalid.

If the switching time is abnormal due to the influence of the charging gun, the charging pile records that the switching time of the charging gun is invalid. If the switching time is abnormal due to the influence of the electronic lock of the charging pile, the charging pile records the switching time of the charging gun to be effective. Therefore, in order to distinguish the validity attribute of each switching time within the time distribution data to be able to more effectively predict whether the electronic lock of the charging pile is in the lock jamming critical state, the present embodiment needs to determine the validity attribute of the switching time according to the time distribution data.

For example, when the switching time is the locking time, the time distribution data Tp of the charging pile includes the locking time during which the charging guns of 10 users charge at the same charging pile, as shown in Table 3:

TABLE 3

| Charging | Charging | Charging | Charging | Charging | Charging | Charging | Charging | Charging | Charging |
|---|---|---|---|---|---|---|---|---|---|
| gun 1 | gun 2 | gun 3 | gun 4 | gun 5 | gun 6 | gun 7 | gun 8 | gun 9 | gun 10 |
| Tp1 | Tp2 | Tp3 | Tp4 | Tp5 | Tp6 | Tp7 | Tp8 | Tp9 | Tp10 |
| 1.0 | 0.8 | 1.0 | 1.0 | 2.2 | 1.0 | 0.9 | 0.95 | 3.2 | 1.0 |

As shown in Table 3, the locking time Tp5 of the charging gun 5 is 2.2 seconds, the locking time Tp9 of the charging gun 9 is 3.2 seconds, and the locking time of the charging gun 5 and the charging gun 9 is relatively different from the locking time of other users. In the present embodiment, in combination with the screening rule, the validity attribute of the locking time Tp5 of the charging gun 5 is set as an invalid attribute, the validity attribute of the locking time Tp9 of the charging gun 9 is set as an invalid attribute, and the validity attributes of the locking times of the remaining users are set as valid attributes; therefore, after S721 is executed, the validity attributes for each user's locking time are as shown in Table 4:

TABLE 4

| Charging | Charging | Charging | Charging | Charging | Charging | Charging | Charging | Charging | Charging |
|---|---|---|---|---|---|---|---|---|---|
| gun 1 | gun 2 | gun 3 | gun 4 | gun 5 | gun 6 | gun 7 | gun 8 | gun 9 | gun 10 |
| Tp1 | Tp2 | Tp3 | Tp4 | Tp5 | Tp6 | Tp7 | Tp8 | Tp9 | Tp10 |
| 1.0 | 0.8 | 1.0 | 1.0 | 2.2 | 1.0 | 0.9 | 0.95 | 3.2 | 1.0 |
| Valid | Valid | Valid | Valid | Invalid | Valid | Valid | Valid | Invalid | Valid |

In S722, in some embodiments, the present embodiment compares the validity attribute for each switching time with an attribute tag, and records the switching time in a first queue if the validity attribute matches the attribute tag, and records the switching time in a second queue if the validity attribute does not match the validity tag, wherein the attribute tag can be either a valid attribute tag or an invalid attribute tag. In conjunction with the above example, after execution of S722, the first queue L1={Tp1, Tp2, Tp3, Tp4, Tp6, Tp7, Tp8, Tp10} and the second queue L2= {Tp5, Tp9}.

In S723, in some embodiments, since the validity attributes of the switching time recorded by the first queue are all valid attributes, the present embodiment may generate a lock jamming feature based on the switching time of the first queue. In addition, since the switching time as a valid attribute has been excluded from being affected by a bad charging gun, the generated lock jamming feature can reliably and efficiently reflect whether the electronic lock is in a lock jamming critical state.

It will be appreciated that in addition to the factors of the charging gun affecting the validity attribute of the switching time, there may also be other factors affecting the validity attribute of the switching time, such as environmental factors of the operation of the charging pile or an electronic lock for man-made malicious operation of the charging pile, but the method provided by the present embodiment may also be applicable to the effects of other factors on the validity attribute of the switching time, and the lock jamming feature can also be accurately and reliably generated.

In some embodiments, the validity attribute includes a valid attribute and an invalid attribute, referring to FIG. 9, S721 includes:

S7211: determining whether a target charging gun corresponding to the switching time satisfies a gun body fault condition.

S7212: if so, determining the validity attribute of the switching time as an invalid attribute.

S7213: if not, determining the validity attribute of the switching time as a valid attribute.

In S7211, the target charging gun is the charging gun corresponding to each switching time in the time distribution data; as shown in Table 3, the locking time Tl corresponds to the charging gun of user 1; and when S7211 is executed, the charging gun of user 1 can be the target charging gun. Then, the locking time T2 corresponds to the charging gun of the user 2, and when S7211 is executed, the charging gun of the user 2 can be the target charging gun, and so on.

The gun body fault condition is a condition for judging whether there is an abnormal condition when the target charging gun performs a switching operation, and the designer may creat the gun body fault condition on his own according to engineering experience.

In S7212, since the target charging gun corresponding to the switching time satisfies the gun body fault condition, the validity attribute of the switching time is an invalid attribute, which does not participate in the generation of the lock jamming feature to avoid affecting the judgment result of pre-determining whether the electronic lock is in a lock jamming critical state.

In S7213, since a target charging gun corresponding to a switching time does not satisfy a gun body fault condition, the target charging gun is good when performing a switching operation, and a validity attribute of the switching time is a valid attribute, which can participate in the generation of a lock jamming feature, so that whether an electronic lock is in a lock jamming critical state can be accurately and reliably pre-judged.

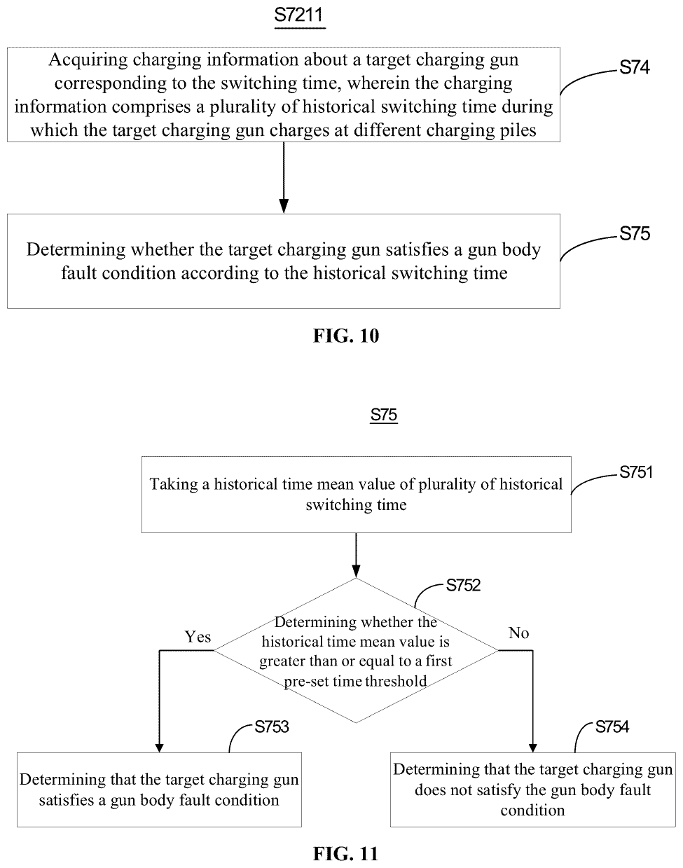

In some embodiments, when determining whether the target charging gun corresponding to the switching time satisfies the gun body fault condition in the present embodiment, referring to FIG. 10, S7211 includes:

S74: acquiring charging information about a target charging gun corresponding to the switching time, wherein the charging information includes a plurality of historical switching time during which the target charging gun charges at different charging piles.

S75: determining whether the target charging gun satisfies a gun body fault condition according to the historical switching time.

In S74, the historical switching time is the switching time of the target charging gun during which the other charging piles are charged with respect to the current charging pile. For example, for the charging gun Q1, when the switching time is the locking time, Table 5 can be summarized from the data provided in Table 1, referring to Table 5:

TABLE 5

| Charging pile 1 | Charging pile 2 | Charging pile 3 | Charging pile 4 |
|---|---|---|---|
| SNZ10000 | SNZ20022 | SNZ10001 | SNZ30045 |
| Tq1 | Tq2 | Tq3 | Tq4 |
| 1.0 | 1.0 | 0.9 | 0.9 |

It can be seen from Table 5 that the charging gun Q1 has been used on the charging pile 1, the charging pile 2, the charging pile 3 and the charging pile 4, respectively, wherein the switching time Tq1, the switching time Tq2, the switching time Tq3 and the switching time Tq4 are all historical switching time, and therefore the charging information Tq of the charging gun Q1 is {Tq1, Tq2, Tq3, Tq4}.

In S75, the present embodiment may determine whether the target charging gun satisfies the gun body fault condition based on the historical switching time of the charging information in combination with the corresponding rule.

In some embodiments, referring to FIG. 11, S75 includes:

S751: calculating a historical time mean value of plurality of historical switching time.

S752: determining whether the historical time mean value is greater than or equal to a first pre-set time threshold.

S753: if so, determining that the target charging gun satisfies a gun body fault condition.

S754: if not, determining that the target charging gun does not satisfy the gun body fault condition.

In S751, in some embodiments, according to the present embodiment, a plurality of historical switching time is added to obtain a historical time sum, and the historical time sum is divided by the number of historical switching time to obtain a historical time mean value. For example, suppose that the charging information Tq of the charging gun Q1 is {Tq1, Tq2, Tq3, Tq4, Tq5, Tq6, Tq7, Tq8, Tq9, Tq10},

$${Tq}^{′} = \frac{{\sum }_{i}^{n = 10} {Tq}_{i}}{10} ,$$

where Tq′ is a historical time mean value.

The difference with the above-mentioned embodiment is that in some embodiments, according to the present embodiment, the maximum historical switching time and the minimum historical switching time are eliminated from the plurality of historical switching time, the remaining historical switching time is added to obtain a historical time sum, and the historical time sum is divided by the number of the remaining historical switching time to obtain a historical time mean value. For example, if Tq3 is the minimum historical switching time and Tq8 is the maximum historical switching time, according to the present embodiment, the minimum historical switching time Tq3 and the maximum historical switching time Tq8 are eliminated and the historical time mean value of the remaining historical switching time is calculated.

In S752, the first pre-set time threshold may be customized by the designer based on engineering experience, e.g., 1.5 seconds or 2 seconds or 2.5 seconds or 3 seconds, etc.

In S753, since the historical time mean value is greater than or equal to the first pre-set time threshold, it is indicated that an abnormality occurs when the target charging gun performs the switching operation, the present embodiment can determine that the target charging gun satisfies the gun body fault condition, and the validity attribute of the switching time of the target charging gun when charging the charging pile is an invalid attribute, and therefore according to the present embodiment, the switching time of the target charging gun needs to be eliminated from the time distribution data.

In S754, since the historical time mean value is less than the first pre-set time threshold, it is indicated that the target charging gun is considered to be normal when the switching operation is performed, the present embodiment can determine that the target charging gun does not satisfy the gun body fault condition, and the validity attribute of the switching time of the target charging gun when the charging pile is charged is a valid attribute, and therefore, according to the present embodiment, the switching time of the target charging gun is retained in the time distribution data.

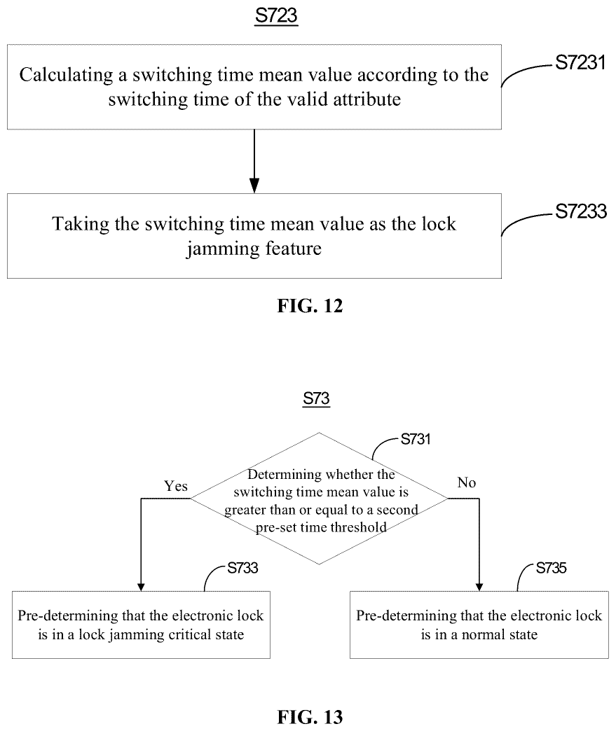

In some embodiments, according to the present embodiment, the lock jamming feature is generated according to the switching time of the valid attribute, referring to FIG. 12, S723 includes:

S7231: calculating a switching time mean value according to the switching time of the valid attribute.

S7233: taking the switching time mean value as the lock jamming feature.

In S7231, in some embodiments, according to the present embodiment, the switching time of the plurality of valid attributes are added to obtain a sum of the switching time, and the sum of the switching time is divided by the number of the switching time of the valid attributes to obtain a switching time mean value. For example, the time distribution data Ts={Ts1, Ts2, Ts3, Ts4, Ts5, Ts6, Ts7, Ts8, Ts9, Ts10}, since the validity attributes of the switching time Ts4 and the switching time Ts7 are invalid attributes, according to the present embodiment, the switching time Ts4 and the switching time Ts7 are eliminated from the time distribution data, and the remaining time distribution data Ts={Ts1, Ts2, Ts3, Ts5, Ts6, Ts8, Ts9, Ts10}, therefore, the number of the switching time of the valid attributes is 8, the sum of the switching time Tₜₒₜₐₗ=Ts1+Ts2+Ts3+Ts5+Ts6+Ts8+Ts9+Ts10, and the switching time mean value is Tₜₒₜₐₗ/8.

In S7233, the switching time mean value Tₜₒₜₐₗ/8 is the lock jamming feature as previously described.

The difference with the above-mentioned embodiments is that in some embodiments, according to the present embodiment, the maximum switching time and the minimum switching time are eliminated from the switching time of the plurality of valid attributes, the remaining switching time is added to obtain a total switching time, and the total switching time is divided by the number of the switching time of the valid attributes to obtain a switching time mean value.

In some embodiments, according to the present embodiment, when whether the electronic lock is in a lock jamming critical state is pre-judged according to the lock jamming feature, referring to FIG. 13, S73 includes:

S731: determining whether the switching time mean value is greater than or equal to a second pre-set time threshold.

S733: if the switching time mean value is greater than or equal to a second pre-set time threshold, pre-determining that the electronic lock is in a lock jamming critical state.

S735: if the switching time mean value is greater than or equal to a second pre-set time threshold, ipre-determining that the electronic lock is in a normal state.

In S731, the second pre-set time threshold may be customized by a designer based on engineering experience, for example, 1.5 seconds or 2 seconds or 2.5 seconds or 3 seconds, etc.

In S733, since the switching time mean value is greater than or equal to the second pre-set time threshold, it is indicated that the electronic lock of the charging pile is abnormal and the lock jamming phenomenon is likely to occur, and therefore according to the present embodiment, it can be predicted that the electronic lock is in the lock jamming critical state.

In some embodiments, if the switching time mean value is greater than the maximum pre-set time threshold, it is indicated that the electronic lock of the charging pile is already in a lock jamming state.

In S735, since the switching time mean value is less than the second pre-set time threshold, it is indicated that the electronic lock of the charging pile is normally operated, and therefore, according to the present embodiment, it can be predicted that the electronic lock is in a normal state.

According to the present embodiment, can accurately and reliably reflect whether an electronic lock is in a lock jamming critical state is pre-determined by taking a switch mean time value and using the switch mean time value as a lock jamming feature according to the lock jamming feature, in this way, using more switching time to participate in the calculation can accurately and reliably reflect whether the electronic lock is in a lock jamming critical state or not.

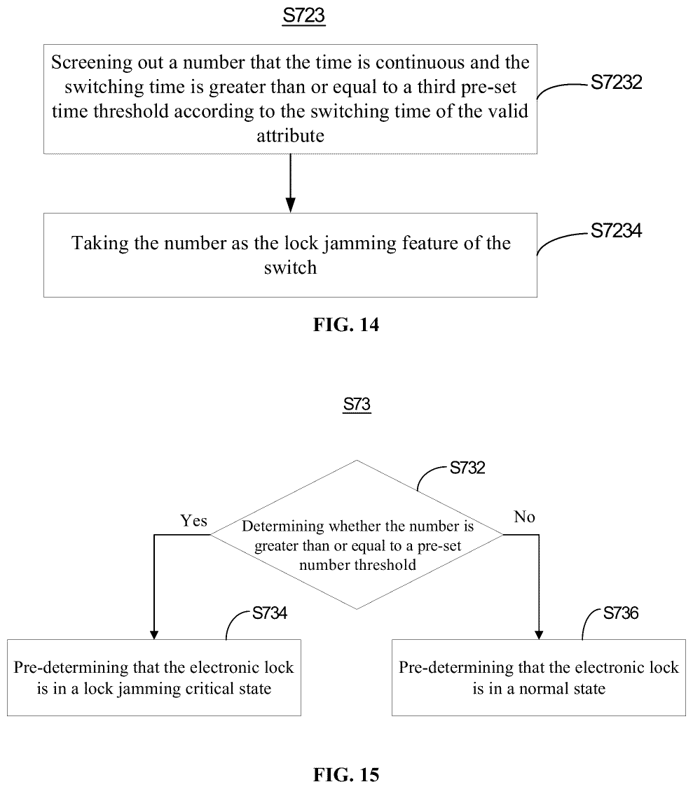

The difference with the above-mentioned embodiments is that in some embodiments, according to the present embodiment, the lock jamming feature is generated according to the switching time of the valid attribute, referring to FIG. 14, S723 includes:

S7232: screening out a number that the time is continuous and the switching time is greater than or equal to a third pre-set time threshold according to the switching time of the valid attribute.

S7234: taking the number as the lock jamming feature of the switch.

In S7232, For example, the time distribution data Ts={Ts1, Ts2, Ts3, Ts4, Ts5, Ts6, Ts7, Ts8, Ts9, Ts10}, since the validity attributes of the switching time Ts4 and the switching time Ts7 are invalid attributes, according to the present embodiment, the switching time Ts4 and the switching time Ts7 are eliminated from the time distribution data, and the remaining time distribution data Ts={Ts1, Ts2, Ts3, Ts5, Ts6, Ts8, Ts9, Ts10}.

In the remaining time distribution data Ts={Ts1, Ts2, Ts3, Ts5, Ts6, Ts8, Ts9, Ts10}, since the switching time Ts1, the switching time Ts8, Ts9 and Ts10 are all less than the third pre-set time threshold, and the switching time Ts2, Ts3, Ts5 and Ts6 are all greater than the third pre-set time threshold, the number is 4.

In S7234, the number 4 is a lock jamming feature.

In some embodiments, according to the present embodiment, when whether the electronic lock is in a lock jamming critical state is pre-determined according to the lock jamming feature, referring to FIG. 15, S73 includes:

S732: determining whether the number is greater than or equal to a pre-set number threshold.

S734: if the number is greater than or equal to the pre-set number threshold, pre-determining the electronic lock being in a lock jamming critical state.

S736: if the number is less than the pre-set number threshold, pre-determining the electronic lock being in a normal state.

In S732, the pre-set quantity threshold may be customized by a designer based on engineering experience, for example, the pre-set quantity threshold is 3 or 4 or 5, etc.

In S734, since the number is greater than or equal to the pre-set number threshold, it is indicated that the electronic lock of the charging pile is abnormal and the lock jamming phenomenon is likely to occur, and therefore according to the present embodiment, it can be predicted that the electronic lock is in the lock jamming critical state.

In some embodiments, if the number is greater than the maximum pre-set number threshold, it is indicated that the electronic lock of the charging pile is already in a lock jamming state, such as a maximum pre-set number threshold of 8 or 10.

In S736, since the number is less than the pre-set number threshold, it is indicated that the electronic lock of the charging pile is normally operated, and therefore, according to the present embodiment, it can be predicted that the electronic lock is in a normal state.

In the present embodiment, by calculating the number and taking the number as a lock jamming feature, whether the electronic lock is in a lock jamming critical state is pre-determined according to the lock jamming feature; in this way, using less switching time, whether the electronic lock is in a lock jamming critical state can be quickly pre-determined, which can satisfy some scenes requiring real-time pre-determination of the lock jamming.

In order to elaborate the present embodiment, the present embodiment provides two application scenes to illustrate this as follows:

First Application Scene:

the present disclosure scene is described in detail in conjunction with Tables 6 and 7, in which the data shown in Table 6 is the data of 10 users charging by the charging pile Z1, and the data shown in Table 7 is the data of 10 users' charging guns charging at different charging piles shown in Table 6, please refer to Tables 6 and 7:

TABLE 6

| Charging | Charging | Charging | Charging | Charging | Charging | Charging | Charging | Charging | Charging |
|---|---|---|---|---|---|---|---|---|---|
| gun 1 | gun 2 | gun 3 | gun 4 | gun 5 | gun 6 | gun 7 | gun 8 | gun 9 | gun 10 |
| Tr1 | Tr2 | Tr3 | Tr4 | Tr5 | Tr6 | Tr7 | Tr8 | Tr9 | Tr10 |
| 1.0 | 0.8 | 1.0 | 1.0 | 2.2 | 1.0 | 0.9 | 0.9 | 3.2 | 1.0 |

TABLE 7

| Charging | | | | | | | | | | | |
|---|---|---|---|---|---|---|---|---|---|---|---|
| gun serial | | | | | | | | | | | Mean |
| number | Tv1 | Tv2 | Tv3 | Tv4 | Tv5 | Tv6 | Tv7 | Tv8 | Tv9 | Tv10 | value |
| Charging | 1.0 | 0.9 | 1.0 | 0.9 | 1.1 | 1.0 | 1.0 | 1.2 | 1.0 | 1.0 | 1.01 |
| gun 1 | | | | | | | | | | | |
| Charging | 0.8 | 0.9 | 1.0 | 0.9 | 1.0 | 1.0 | 1.1 | 1.2 | 1.0 | 1.2 | 1.01 |
| gun 2 | | | | | | | | | | | |
| Charging | 1.0 | 1.2 | 1.1 | 1.0 | 1.0 | 1.2 | 1.1 | 0.9 | 1.1 | 1.0 | 1.06 |
| gun 3 | | | | | | | | | | | |
| Charging | 1.0 | 0.9 | 1.2 | 0.9 | 1.1 | 1.1 | 1.0 | 1.2 | 1.2 | 1.1 | 1.07 |
| gun 4 | | | | | | | | | | | |
| Charging | 2.2 | 2.3 | 2.2 | 2.3 | 2.1 | 2.4 | 2.3 | 2.1 | 2.4 | 2.4 | 2.27 |
| gun 5 | | | | | | | | | | | |
| Charging | 1.0 | 0.9 | 1.0 | 1.1 | 0.9 | 1.0 | 1.1 | 1.2 | 1.1 | 1.0 | 1.03 |
| gun 6 | | | | | | | | | | | |
| Charging | 0.9 | 1.1 | 1.0 | 0.9 | 1.1 | 1.2 | 1.0 | 1.1 | 1.0 | 1.0 | 1.04 |
| gun 7 | | | | | | | | | | | |
| Charging | 0.9 | 0.9 | 1.0 | 0.9 | 1.1 | 1.2 | 1.0 | 1.2 | 1.1 | 0.9 | 1.02 |
| gun 8 | | | | | | | | | | | |
| Charging | 3.2 | 3.4 | 3.2 | 3.3 | 3.2 | 3.3 | 3.1 | 3.4 | 3.3 | 3.0 | 3.24 |
| gun 9 | | | | | | | | | | | |
| Charging | 1.0 | 0.9 | 1.1 | 1.0 | 1.1 | 1.0 | 1.1 | 1.2 | 1.0 | 1.0 | 1.04 |
| gun 10 | | | | | | | | | | | |

As shown in Table 6, when each of the charging guns 1 to 10 is charged at the charging pile Z1, time distribution data Tr={1.0, 0.8, 1.0, 1.0, 2.2, 1.0, 0.9, 0.9, 3.2, 1.0} are obtained as shown in Table 6.

As shown in Table 7, the switching time of the charging gun 1 charging at the charging piles 10 is {1.0, 0.9, 1.0, 0.9, 1.1, 1.0, 1.0, 1.2, 1.0, 1.0}, and the switching time of other charging guns charging at the 10 charging piles is obtained by the same reasoning.

Assuming that the first pre-set time threshold is 2, since the switching time mean value of the charging gun 1, the charging gun 2, the charging gun 3, the charging gun 4, the charging gun 6, the charging gun 7, the charging gun 8 and the charging gun 10 are all less than 2, but the switching time mean value of the charging gun 5 and the charging gun 9 are both greater than 2, the validity attributes of the switching time of the charging gun 5 and the charging gun 9 are invalid attributes, and in the present embodiment, it is necessary to eliminate the switching time Tr5 of the charging gun 5 and the switching time Tr9 of the charging gun 9 from the time distribution data Tr, and the validity attribute of the remaining switching time {1.0, 0.8, 1.0, 1.0, 1.0, 0.9, 0.9, 1.0} in the time distribution data Tr is a valid attribute.

According to the present embodiment, the switching time mean value is calculated according to the switching time of the valid attribute, so that it can be obtained that the switching time mean value is 0.95, so that the lock jamming feature is 0.95. Assuming that the second pre-set time threshold is 1.5, since 0.95 is less than 1.5, the present embodiment pre-judges that the electronic lock is in a normal state.

Second Application Scene:

the present disclosure scene is described in detail in conjunction with Tables 8 and 9, in which the data shown in Table 8 is the data of 10 users charging by the charging pile Z1, and the data shown in Table 9 is the data of 10 users' charging guns charging at different charging piles shown in Table 8, please refer to Tables 8 and 9:

TABLE 8

| Charging | Charging | Charging | Charging | Charging | Charging | Charging | Charging | Charging | Charging |
|---|---|---|---|---|---|---|---|---|---|
| gun 1 | gun 2 | gun 3 | gun 4 | gun 5 | gun 6 | gun 7 | gun 8 | gun 9 | gun 10 |
| Tx1 | Tx2 | Tx3 | Tx4 | Tx5 | Tx6 | Tx7 | Tx8 | Tx9 | Tx10 |
| 2.2 | 2.4 | 2.5 | 2.2 | 4.2 | 2.2 | 2.1 | 2.3 | 5.4 | 2.4 |

TABLE 9

| Charging | | | | | | | | | | | |
|---|---|---|---|---|---|---|---|---|---|---|---|
| gun serial | | | | | | | | | | | Mean |
| number | Ty1 | Ty2 | Ty3 | Ty4 | Ty5 | Ty6 | Ty7 | Ty8 | Ty9 | Ty10 | value |
| Charging | 2.2 | 0.9 | 1.0 | 0.9 | 1.1 | 1.0 | 1.0 | 1.2 | 1.0 | 1.0 | 1.12 |
| gun 1 | | | | | | | | | | | |
| Charging | 2.4 | 0.9 | 1.0 | 0.9 | 1.0 | 1.0 | 1.1 | 1.2 | 1.0 | 1.2 | 1.17 |
| gun 2 | | | | | | | | | | | |
| Charging | 2.5 | 1.2 | 1.1 | 1.0 | 1.0 | 1.2 | 1.1 | 0.9 | 1.1 | 1.0 | 1.21 |
| gun 3 | | | | | | | | | | | |
| Charging | 2.2 | 0.9 | 1.2 | 0.9 | 1.1 | 1.1 | 1.0 | 1.2 | 1.2 | 1.1 | 1.19 |
| gun 4 | | | | | | | | | | | |
| Charging | 4.2 | 2.3 | 2.2 | 2.3 | 2.1 | 2.4 | 2.3 | 2.1 | 2.4 | 2.4 | 2.47 |
| gun 5 | | | | | | | | | | | |
| Charging | 2.2 | 0.9 | 1.0 | 1.1 | 0.9 | 1.0 | 1.1 | 1.2 | 1.1 | 1.0 | 1.15 |
| gun 6 | | | | | | | | | | | |
| Charging | 2.1 | 1.1 | 1.0 | 0.9 | 1.1 | 1.2 | 1.0 | 1.1 | 1.0 | 1.0 | 1.16 |
| gun 7 | | | | | | | | | | | |
| Charging | 2.3 | 0.9 | 1.0 | 0.9 | 1.1 | 1.2 | 1.0 | 1.2 | 1.1 | 0.9 | 1.16 |
| gun 8 | | | | | | | | | | | |
| Charging | 5.4 | 3.4 | 3.2 | 3.3 | 3.2 | 3.3 | 3.1 | 3.4 | 3.3 | 3.0 | 3.46 |
| gun 9 | | | | | | | | | | | |
| Charging | 2.4 | 0.9 | 1.1 | 1.0 | 1.1 | 1.0 | 1.1 | 1.2 | 1.0 | 1.0 | 1.18 |
| gun 10 | | | | | | | | | | | |

As shown in Table 8, when each of the charging guns 1 to 10 is charged at the charging pile Z1, time distribution data Tx={2.2, 2.4, 2.5, 2.2, 4.2, 2.2, 2.1, 2.3, 5.4, 2.4} are obtained as shown in Table 8.

As shown in Table 9, the switching time of the charging gun 1 charging at the charging piles 10 is {2.2, 0.9, 1.0, 0.9, 1.1, 1.0, 1.0, 1.2, 1.0, 1.0}, and the switching time of other charging guns charging at the 10 charging piles is obtained by the same reasoning.

Assuming that the first pre-set time threshold is 2, since the switching time mean value of the charging gun 1, the charging gun 2, the charging gun 3, the charging gun 4, the charging gun 6, the charging gun 7, the charging gun 8 and the charging gun 10 are all less than 2, but the switching time mean value of the charging gun 5 and the charging gun 9 are both greater than 2, the validity attributes of the switching time of the charging gun 5 and the charging gun 9 are invalid attributes, and in the present embodiment, it is necessary to eliminate the switching time Tx5 of the charging gun 5 and the switching time Tx9 of the charging gun 9 from the time distribution data Tx, and the validity attribute of the remaining switching time {2.2, 2.4, 2.5, 2.2, 2.2, 2.1, 2.3, 2.4} in the time distribution data Tx is a valid attribute.

According to the present embodiment, the switching time mean value is calculated according to the switching time of the valid attribute, so that it can be obtained that the switching time mean value is 2.2875, so that the lock jamming feature is 0.95. Assuming that the second pre-set time threshold is 1.5, since 2.2875 is greater than 1.5, the present embodiment pre-determines that the electronic lock is in the lock jamming critical state.

In general, the present embodiment can automatically pre-determine whether the electronic lock is in a lock jamming critical state, so that the manager of the charging pile takes corresponding maintenance work, which is beneficial to improve the user experience.

It should be noted that in the above-mentioned embodiments, there is not necessarily a certain order between the above-mentioned steps, and a person skilled in the art would have been able to understand, according to the description of the embodiments in the present disclosure, that in different embodiments, the above-mentioned steps can be performed in different orders, i.e., can be performed in parallel, can be performed in exchange, etc.

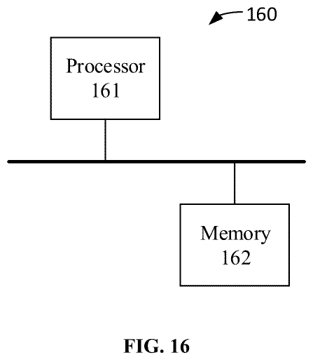

Referring to FIG. 16, FIG. 16 is a schematic structural diagram showing a circuit configuration of an electronic device according to an embodiment of the present disclosure, wherein the electronic device may be a socket-type charging pile or a server or other devices. As shown in FIG. 16, the electronic device 160 includes one or more processors 161 and a memory 162. A processor 161 is exemplified in FIG. 16.

The processors 161 and the memory 162 may be connected via a bus or in other ways, and via a bus connection exemplified in FIG. 9.

The memory 162 serves as a non-volatile computer-readable storage medium for storing non-volatile software programs, non-volatile computer-executable programs, and modules, such as program instructions/modules, corresponding to the method for pre-determining lock jamming of an electronic lock of a socket-type charging pile in embodiments of the present disclosure. The processor 161 implements the functions of the method for pre-determining lock jamming of an electronic lock of a socket-type charging pile provided by the above-described method embodiments by executing non-volatile software programs, instructions and modules stored in the memory 162.

The memory 162 may include high-speed random-access memory, and may also include non-volatile memory, such as at least one magnetic disk storage device, flash memory device, or other non-volatile solid state storage device. In some embodiments, the memory 162 may optionally include memories remotely located with respect to a processor 161, which may be connected to the processor 161 via a network. Embodiments of such networks include, but are not limited to, the Internet, Intranets, local area networks, mobile communication networks, and combinations thereof.

The program instructions/modules are stored in the memory 162 and, when executed by the one or more processors 161, perform the tool state monitoring method of any of the method embodiments described above.

Embodiments of the present disclosure also provide a computer-readable storage medium having stored thereon computer-executable instructions that, when executed by one or more processors, such as processor 161 of FIG. 16, may cause the one or more processors to perform the method for pre-determining lock jamming of an electronic lock of a socket-type charging pile in any of the method embodiments described above.

In a fifth aspect, embodiments of the present disclosure further provide a computer program product including a computer program stored on a computer readable storage medium computer program including program instructions which, when executed by an electronic device, cause the electronic device to perform the method for pre-determining lock jamming of an electronic lock of a socket-type charging pile as described by any of the above.

The apparatus or device embodiments described above are merely illustrative, wherein the unit modules illustrated as separate components may or may not be physically separated, and the components shown as modular units may or may not be physical units, i.e., may be in one place, or may also be distributed over multiple network modular units. Some or all the modules may be selected according to actual needs to achieve the purpose of the solution of the present embodiment.

From the above description of the embodiments, it will be clear to a person skilled in the art that the embodiments can be implemented by means of software plus a general-purpose hardware platform, but also by means of hardware. Based on such understanding, the technical solutions in essence or part contributing to the related art can be embodied in the form of a software product, which can be stored in a computer readable storage medium, such as ROM/RAM, magnetic disk, compact disk, etc., and includes several instructions for causing a computer device (which can be a personal computer, a server, or a network device, etc.) to perform the method according to various embodiments or some parts of embodiments.

Finally, it should be noted that: the above-mentioned embodiments are merely illustrative of the technical solution of the present disclosure, and do not limit same; the technical features in the above embodiments or in different embodiments may also be combined under the idea of the present disclosure, the steps may be implemented in any order, and there are many other variations of the different aspects of the present disclosure as above, which are not provided in the details for the sake of brevity; although the present disclosure has been described in detail Referring to the foregoing embodiments, a person skilled in the art will appreciate that: the technical solutions disclosed in the above-mentioned embodiments can still be amended, or some of the technical features thereof can be replaced by equivalents; however, these modifications or substitutions do not bring the essence of the corresponding technical solutions out of the scope of the technical solutions of the various an embodiment of the present disclosure.

The above description is only a particular embodiment of the present disclosure, but the scope of protection of the present disclosure is not limited thereto, and various changes or substitutions will readily occur to a person skilled in the art within the scope of the present disclosure, and these are intended to be within the scope of protection of the present disclosure. Therefore, the scope of protection of the present disclosure should be determined by the scope of protection of the claims.

What is claimed is:

1. A method for pre-determining lock jamming of an electronic lock of a charging pile, the method comprising:
acquiring time distribution data, wherein the charging pile is provided with a socket, the electronic lock is installed on the socket for performing a switching operation on one or more charging guns which are inserted into the socket, and the time distribution data comprises one or more switching time during which the electronic lock performs the switching operation on the one or more charging guns;
generating one or more lock jamming features corresponding to the one or more switching time according to the time distribution data; and
pre-determining whether the electronic lock is in a lock jamming critical state according to the one or more lock jamming features.

2. The method according to claim 1, wherein the generating one or more lock jamming features corresponding to the one or more switching time according to the time distribution data comprises:
determining one or more validity attributes of the one or more switching time according to the time distribution data;
extracting a switching time with a valid attribute according to the one or more validity attributes of the one or more switching time; and
generating a lock jamming feature according to the switching time with the valid attribute.

3. The method according to claim 2, wherein a validity attribute comprising a valid attribute and an invalid attribute, wherein the determining the one or more validity attribute of the one or more switching time according to the time distribution data comprises:
determining whether a target charging gun corresponding to a switching time satisfies a gun body fault condition;
in response to determining that the target charging gun corresponding to the switching time satisfies the gun body fault condition, determining the validity attribute of the switching time as the invalid attribute; and
in response to determining that the target charging gun corresponding to the switching time does not satisfy the gun body fault condition, determining the validity attribute of the switching time as the valid attribute.

4. The method according to claim 3, wherein the determining whether the target charging gun corresponding to the switching time satisfies the gun body fault condition comprises:
acquiring charging information of the target charging gun corresponding to the switching time, wherein the charging information comprises a plurality of historical switching time during which the target charging gun charges at different charging piles; and
determining whether the target charging gun satisfies the gun body fault condition according to the plurality of historical switching time.

5. The method according to claim 4, wherein the determining whether the target charging gun satisfies the gun body fault condition according to the plurality of historical switching time comprises:
taking a historical time mean value of the plurality of historical switching time;
in response to determining that the historical time mean value is greater than or equal to a first pre-set time threshold, determining that the target charging gun satisfies the gun body fault condition; and
in response to determining that the historical time mean value is less than the first pre-set time threshold, determining that the target charging gun does not satisfy the gun body fault condition.

6. The method according to claim 2, wherein the generating the lock jamming feature according to the switching time with the valid attribute comprises:
calculating a switching time mean value according to the switching time with the valid attribute; and
taking the switching time mean value as the lock jamming feature.

7. The method according to claim 6, wherein the pre-determining whether the electronic lock is in the lock jamming critical state according to the one or more lock jamming features comprises:
in response to determining that the switching time mean value is greater than or equal to the second pre-set time threshold, pre-determining that the electronic lock is in the lock jamming critical state; and
in response to determining that the switching time mean value is less than the second pre-set time threshold, pre-determining that the electronic lock is in a normal state.

8. The method according to claim 2, wherein the generating the lock jamming feature according to the switching time with the valid attribute comprises:
screening out a number of the switching time that is continuous and is greater than or equal to a third pre-set time threshold according to the switching time with the valid attribute; and
taking the number as the lock jamming feature.

9. The method according to claim 8, wherein the pre-determining whether the electronic lock is in the lock jamming critical state according to the one or more lock jamming features comprises:
in response to determining that the number is greater than or equal to the pre-set number threshold, pre-determining that the electronic lock is in the lock jamming critical state; and
in response to determining that the number is less than the pre-set number threshold, pre-determining that the electronic lock is in a normal state.

10. A socket-type charging pile, comprising:
a pile body;
a socket installed on the pile body for inserting in a charging gun;
an electronic lock installed on the socket; and
a controller electrically connected to the electronic lock for performing acts comprising:
acquiring time distribution data, wherein the charging pile is provided with a socket, the electronic lock is installed on the socket for performing a switching operation on one or more charging guns which are inserted into the socket, and the time distribution data comprises one or more switching time during which the electronic lock performs the switching operation on the one or more charging guns;
generating one or more lock jamming features corresponding to the one or more switching time according to the time distribution data; and
pre-determining whether the electronic lock is in a lock jamming critical state according to the one or more lock jamming features.

11. The socket-type charging pile according to claim 10, wherein the generating one or more lock jamming features corresponding to the one or more switching time according to the time distribution data comprises:
determining one or more validity attributes of the one or more switching time according to the time distribution data;
extracting a switching time with a valid attribute according to the one or more validity attributes of the one or more switching time; and
generating a lock jamming feature according to the switching time with the valid attribute.

12. The socket-type charging pile according to claim 11, wherein a validity attribute comprising a valid attribute and an invalid attribute, wherein the determining the one or more validity attribute of the one or more switching time according to the time distribution data comprises:
determining whether a target charging gun corresponding to a switching time satisfies a gun body fault condition;
in response to determining that the target charging gun corresponding to the switching time satisfies the gun body fault condition, determining the validity attribute of the switching time as the invalid attribute; and
in response to determining that the target charging gun corresponding to the switching time does not satisfy the gun body fault condition, determining the validity attribute of the switching time as the valid attribute.

13. The socket-type charging pile according to claim 12, wherein the determining whether the target charging gun corresponding to the switching time satisfies the gun body fault condition comprises:
acquiring charging information of the target charging gun corresponding to the switching time, wherein the charging information comprises a plurality of historical switching time during which the target charging gun charges at different charging piles; and
determining whether the target charging gun satisfies the gun body fault condition according to the plurality of historical switching time.

14. The socket-type charging pile according to claim 13, wherein the determining whether the target charging gun satisfies the gun body fault condition according to the plurality of historical switching time comprises:
taking a historical time mean value of the plurality of historical switching time;
in response to determining that the historical time mean value is greater than or equal to a first pre-set time threshold, determining that the target charging gun satisfies the gun body fault condition; and
in response to determining that the historical time mean value is less than the first pre-set time threshold, determining that the target charging gun does not satisfy the gun body fault condition.

15. The socket-type charging pile according to claim 11, wherein the generating the lock jamming feature according to the switching time with the valid attribute comprises:
calculating a switching time mean value according to the switching time with the valid attribute; and
taking the switching time mean value as the lock jamming feature.

16. The socket-type charging pile according to claim 15, wherein the pre-determining whether the electronic lock is in the lock jamming critical state according to the one or more lock jamming features comprises:
in response to determining that the switching time mean value is greater than or equal to the second pre-set time threshold, pre-determining that the electronic lock is in the lock jamming critical state; and
in response to determining that the switching time mean value is less than the second pre-set time threshold, pre-determining that the electronic lock is in a normal state.

17. The socket-type charging pile according to claim 11, wherein the generating the lock jamming feature according to the switching time with the valid attribute comprises:
screening out a number of the switching time that is continuous and is greater than or equal to a third pre-set time threshold according to the switching time with the valid attribute; and
taking the number as the lock jamming feature.

18. The socket-type charging pile according to claim 17, wherein the pre-determining whether the electronic lock is in the lock jamming critical state according to the one or more lock jamming features comprises:
in response to determining that the number is greater than or equal to the pre-set number threshold, pre-determining that the electronic lock is in the lock jamming critical state; and
in response to determining that the number is less than the pre-set number threshold, pre-determining that the electronic lock is in a normal state.

19. A charging apparatus, comprising:
a socket-type charging pile, wherein the socket-type charging pile comprises:
a pile body;
a socket installed on the pile body for inserting in a charging gun;
an electronic lock installed on the socket; and
a controller electrically connected to the electronic lock for performing acts comprising:
acquiring time distribution data, wherein the charging pile is provided with a socket, the electronic lock is installed on the socket for performing a switching operation on one or more charging guns which are inserted into the socket, and the time distribution data comprises one or more switching time during which the electronic lock performs the switching operation on the one or more charging guns;
generating one or more lock jamming features corresponding to the one or more switching time according to the time distribution data; and
pre-determining whether the electronic lock is in a lock jamming critical state according to the one or more lock jamming features; and
a charging gun comprising a gun body, a pile body plug and a vehicle plug, wherein the pile body plug and the vehicle plug are respectively installed on two ends of the gun body, and the electronic lock is configured to perform the switching operation on the pile body plug.

20. The charging apparatus according to claim 19, wherein the generating one or more lock jamming features corresponding to the one or more switching time according to the time distribution data comprises:
determining one or more validity attributes of the one or more switching time according to the time distribution data;
extracting a switching time with a valid attribute according to the one or more validity attributes of the one or more switching time; and
generating a lock jamming feature according to the switching time with the valid attribute.
